(19) United States
(12) Patent Application Publication
(10) Pub. No.: US 2012/0316876 A1
(43) Pub. Date: Dec. 13, 2012

(54) Display Device, Method for Thereof and Voice Recognition System

(76) Inventors: Seokbok Jang, Seoul (KR); Jongse Park, Seoul (KR); Joonyup Lee, Seoul (KR); Jungkyu Choi, Seoul (KR)

(21) Appl. No.: 13/241,426

(22) Filed: Sep. 23, 2011

Related U.S. Application Data
(63) Continuation of application No. PCT/KR2011/004264, filed on Jun. 10, 2011.

(51) Int. Cl. G10L 15/00

(52) U.S. Cl. 704/246; 704/E15.001

(57) ABSTRACT

A display system, a display device, a control method for the display device, and a voice recognition system are disclosed. A display device according to one embodiment of the present invention can carry out voice recognition upon a voice received from at least one speaker through at least one voice input device; and display the voice recognition result on the display unit. Accordingly, effective voice recognition is made possible for TV environments where various constraints exist differently from mobile terminal environments.

### BACKGROUND

1. Field

The present invention relates to a display device, a control method for the display device, and a voice recognition system. More specifically, the present invention relates to a display device capable of effective voice recognition, a control method for the display device, and a voice recognition system in the environment including the display device.

2. Related Art

Nowadays, Television (TV) employs user interface (UI) elements for interaction with users. Various functions (software) of the TV can be provided in the form of a program through the user interface elements; in this respect, various kinds of UI elements are emerging to improve accessibility to TV.

Accordingly, new technology is needed, which can improve usability of TV by managing various UI elements in an efficient manner.

### SUMMARY

The present invention has been made in an effort to provide a display device capable of effective voice recognition, a control method for the display device, and a voice recognition system of the display device in the environment of TV voice recognition system.

The present invention is not limited by the aforementioned objectives and other objectives not mentioned above would be clearly understood by those skilled in the art from the description below.

To achieve the objective, a display device according to one aspect of the present invention comprises a display unit; and a controller carrying out voice recognition for a voice of at least one speaker received through at least one voice input device and displaying the voice recognition result on the display unit by using an indicator related to at least one of the speaker, the voice input device, and the reliability of the voice recognition.

A display system according to another aspect of the present invention has a display device, the display device comprises a display unit; a voice information receiving unit; and a control unit configured to receive voice information from the voice information receiving unit, determine a speaker identity based on the voice information, and display a speaker indicator on the display unit corresponding to the speaker identity.

A control method for a display device according to another aspect of the present invention comprises receiving voice of at least one speaker through at least one voice input device; carrying out voice recognition upon the received voice; and displaying the voice recognition result on the display unit by using an indicator related to at least one of the speaker, the voice input device, and the reliability of the voice recognition.

A control method for a display device according to another aspect of the present invention comprises receiving voice information through a voice information receiving unit; determining a speaker identity based on the voice information; and displaying a speaker indicator on a display unit corresponding to the speaker identity.

A voice recognition system according to yet another aspect of the present invention comprises at least one voice input device receiving voice spoken by at least one speaker; and a display device carrying out voice recognition upon the voice received from the voice input device and providing the voice recognition result by using an indicator related to at least one of the speaker, the voice input device, and the reliability of the voice recognition.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 illustrates briefly a voice recognition system to which the present invention is applied;

FIG. 2 is an overall block diagram of a display device related to one embodiment of the present invention;

FIG. 3 is an overall block diagram of a remote control related to one embodiment of the present invention;

FIG. 4 is a flow diagram illustrating a control method for a display device 100 according to an embodiment of the present invention;

FIGS. 5 to 7 illustrate examples of displaying an indicator corresponding to voice signals of a speaker received through a predetermined voice input device on a display unit;

FIG. 8 is a flow diagram illustrating a control method for a display device according to another embodiment of the present invention;

FIG. 9 is an example of a message window indicating multiple control right owners controlling a display device through voice commands in the case of multiple speakers according to the embodiment illustrated in FIG. 8;

FIG. 10 is a flow diagram of a control method for a display device according to an embodiment of the present invention;

FIGS. 11 to 12 illustrate examples of displaying a speaker indicator according to the control method for a display device illustrated in FIG. 10;

FIG. 13 is a flow diagram of a control method for a display device according to an embodiment of the present invention;

FIGS. 14 to 15 illustrate examples of a speaker indicator according to the control method of a display device illustrated in FIG. 13;

FIG. 16 is a flow diagram of a control method for a display device according to an embodiment of the present invention;

FIG. 17 illustrates an example of displaying a speaker indicator according to the control method of a display device illustrated in FIG. 16;

FIGS. 18 to 20 illustrate embodiments related to setting a user profile according to one example of a control method for a display device according to one embodiment of the present invention;

FIG. 21 is a flow diagram of a control method for a display device according to an embodiment of the present invention;

FIG. 22 is a flow diagram illustrating the S620 step of FIG. 21 in more detail; and

FIGS. 23 to 26 illustrate examples of an indicator related to an input device according to the control method of a display device illustrated in FIG. 22.

### DETAILED DESCRIPTION

Objectives, characteristics, and advantages of the present invention described in detail above will be more clearly understood by the following detailed description. In what follows, preferred embodiments of the present invention will be described in detail with reference to appended drawings. Throughout the document, the same reference number refers to the same element. In addition, if it is determined that specific description about a well-known function or structure related to the present invention unnecessarily brings ambiguity to the understanding of the technical principles of the present invention, the corresponding description will be omitted.

In what follows, a display device related to the present invention will be described in more detail with reference to the appended drawings. The suffix of “module” and “unit” associated with a constituting element employed for the description below does not carry a meaning or a role in itself distinguished from the other.

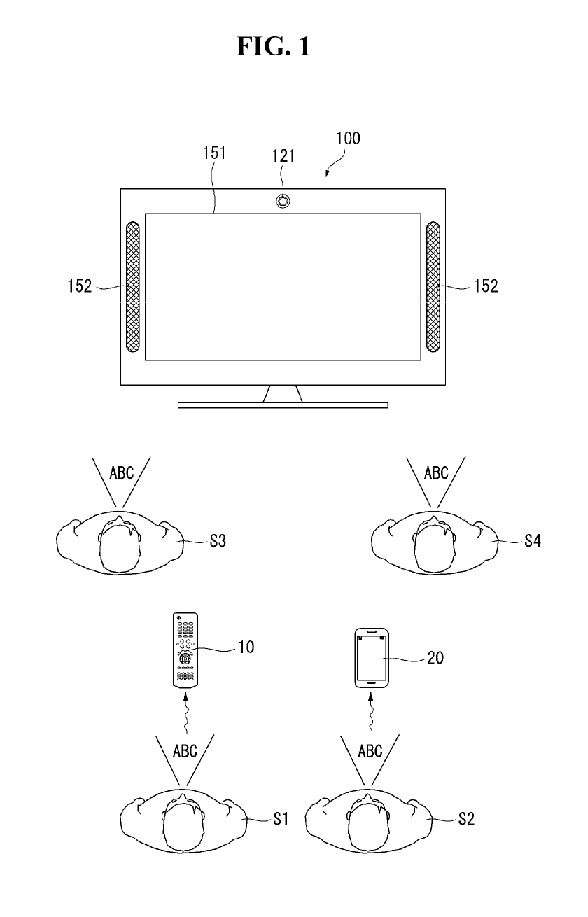

FIG. 1 illustrates briefly a voice recognition system to which the present invention is applied.

As shown in FIG. 1, a voice recognition system to which the present invention is applied comprises a display device 100 and a microphone 122 installed in the main body of the display device 100. Also, the voice recognition system can comprise a remote control 10 and/or a mobile device 20.

The display device 100 can receive voice of a speaker through a voice input device. The voice input device can be a microphone 122 installed inside the display device 100. Also, the voice input device can include at least one of a remote control 10 and a mobile device 20 used outside thereof. In addition, the voice input device can include a microphone array (not shown) connected by wire or wirelessly to the display device 100. The present invention is not limited to the exemplary voice recognition systems described in detail above.

The display device 100 recognizes voice input from the voice input device and outputs the voice recognition result through a predetermined output unit 150. The display device 100 can provide feedback on the input voice for a speaker through the output unit 150. Accordingly, the speaker can know that his or her voice has been recognized through the display device 100.

The display device 100 can provide the voice recognition result for at least one speaker by using at least one of visual, aural, and tactile method.

Meanwhile, at least one voice input device providing voice to the display device 100 can comprise a remote control 100, a mobile device 20, the display device 100, and a microphone array 30 located near the speaker. The voice input device includes at least one microphone which can be operated by the user and receive the speaker's voice.

The display device 100 can be DTV which receives broadcasting signals from a broadcasting station and outputs the signals. Also, the DTV can be equipped with an apparatus capable of connecting to the Internet through TCP/IP (Transmission Control Protocol/Internet Protocol).

The remote control 10 can include a character input button, a direction selection/confirm button, a function control button, and a voice input terminal; the remote control 10 can be equipped with a short-distance communication module which receives voice signals input from the voice input terminal and transmits the received voice signals to the display device 100. The communication module refers to a module for short range communications. Bluetooth, RFID (Radio Frequency Identification), infrared data association (IrDA), Ultra wideband (UWB), and Zigbee can be used for short range communications.

The remote control can be a 3D (three dimensional) pointing device. The 3D pointing device can detect three-dimensional motion and transmit information about the 3D motion detected to the DTV 100. The 3D motion can correspond to a command for controlling the DTV 100. The user, by moving the 3D pointing device in space, can transmit a predetermined command to the DTV 100. The 3D pointing device can be equipped with various key buttons. The user can input various commands by using the key buttons.

The display device 100, as in the remote control 10, can include a microphone 122 collecting a speaker S2's voice and transmit voice signals collected through the microphone 122 to the display device 100 through a predetermined short range communication module 114.

The display device described in this document can include a mobile phone, a smart phone, a laptop computer, a broadcasting terminal, a PDA (Personal Digital Assistant), a PMP (Portable Multimedia Player), and a navigation terminal. However, the scope of the present invention is not limited to those described above.

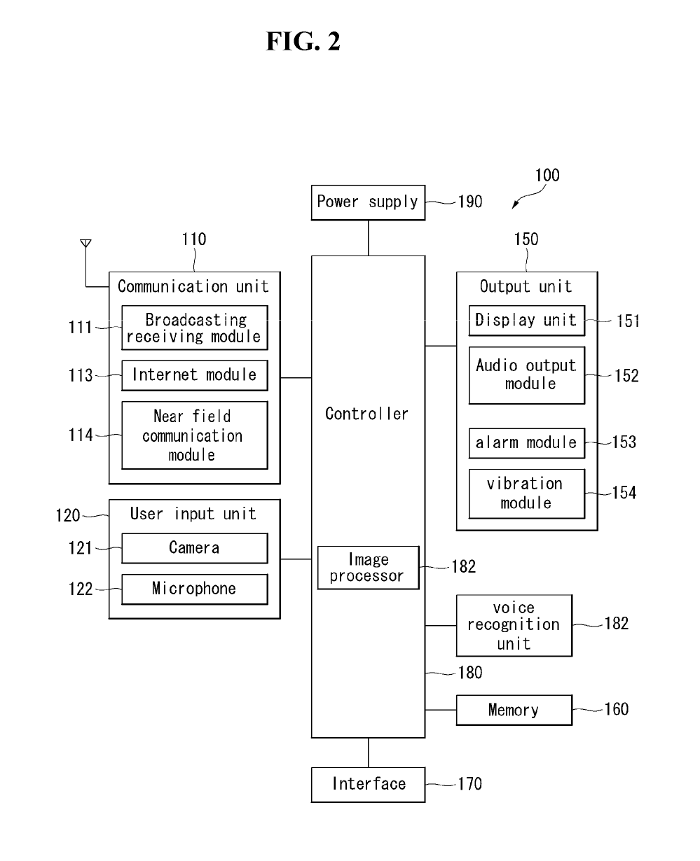

FIG. 2 is a block diagram of a display device 100 according to an embodiment of the present invention. As shown, the display device 100 includes a communication unit 110, an A/V (Audio/Video) input unit 120, an output unit 150, a memory 160, an interface unit 170, a control unit, such as controller 180, and a power supply unit 190, etc. FIG. 2 shows the display device as having various components, but implementing all of the illustrated components is not a requirement. Greater or fewer components may alternatively be implemented.

In addition, the communication unit 110 generally includes one or more components allowing radio communication between the display device 100 and a communication system or a network in which the display device is located. For example, in FIG. 2, the communication unit includes at least one of a broadcast receiving module 111, a wireless Internet module 113, a short-range communication module 114.

The broadcast receiving module 111 receives broadcast signals and/or broadcast associated information from an external broadcast management server via a broadcast channel. Further, the broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

In addition, the broadcast associated information may refer to information associated with a broadcast channel, a broadcast program or a broadcast service provider.

Further, the broadcast signal may exist in various forms. For example, the broadcast signal may exist in the form of an electronic program guide (EPG) of the digital multimedia broadcasting (DMB) system, and electronic service guide (ESG) of the digital video broadcast-handheld (DVB-H) system, and the like.

The broadcast receiving module 111 may also be configured to receive signals broadcast by using various types of broadcast systems. In particular, the broadcast receiving module 111 can receive a digital broadcast using a digital broadcast system such as the multimedia broadcasting-terrestrial (DMB-T) system, the digital multimedia broadcasting-satellite (DMB-S) system, the digital video broadcast-handheld (DVB-H) system, the data broadcasting system known as the media forward link only (MediaFLO®), the integrated services digital broadcast-terrestrial (ISDB-T) system, etc.

The broadcast receiving module 111 can also be configured to be suitable for all broadcast systems that provide a broadcast signal as well as the above-mentioned digital broadcast systems. In addition, the broadcast signals and/or broadcast-associated information received via the broadcast receiving module 111 may be stored in the memory 160.

The Internet module 113 supports Internet access for the display device and may be internally or externally coupled to the display device. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

Further, the short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

With reference to FIG. 2, the A/V input unit 120 is configured to receive an audio or video signal, and may include a camera 121 and a microphone 122 or a voice information receiving unit (not shown). The camera 121 processes image data of still pictures or video obtained by an image capture device in a video capturing mode or an image capturing mode, and the processed image frames can then be displayed on a display unit 151.

Further, the image frames processed by the camera 121 may be stored in the memory 160 or transmitted via the communication unit 110. Two or more cameras 121 may also be provided according to the configuration of the display device.

In addition, the microphone 122 can receive sounds via a microphone in a phone call mode, a recording mode, a voice recognition mode, and the like, and can process such sounds into audio data. The microphone 122 may also implement various types of noise canceling (or suppression) algorithms to cancel or suppress noise or interference generated when receiving and transmitting audio signals.

In addition, the output unit 150 is configured to provide outputs in a visual, audible, and/or tactile manner. In the example in FIG. 2, the output unit 150 includes the display unit 151, an audio output module 152, a vibration module 153, and the like. In more detail, the display unit 151 displays information processed by the image display device 100. For examples, the display unit 151 displays UI or graphic user interface (GUI) related to a displaying image. The display unit 151 displays a captured or/and received image, UI or GUI when the image display device 100 is in the video mode or the photographing mode.

The display unit 151 may also include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of these displays may also be configured to be transparent or light-transmissive to allow for viewing of the exterior, which is called transparent displays.

An example transparent display is a TOLED (Transparent Organic Light Emitting Diode) display, or the like. A rear structure of the display unit 151 may be also light-transmissive. Through such configuration, the user can view an object positioned at the rear side of the terminal body through the region occupied by the display unit 151 of the terminal body.

The audio output unit 152 can output audio data received from the communication unit 110 or stored in the memory 160 in an audio signal receiving mode and a broadcasting receiving mode. The audio output unit 152 outputs audio signals related to functions performed in the image display device 100. The audio output unit 152 may comprise a receiver, a speaker, a buzzer, etc.

The vibration module 153 can generate particular frequencies inducing a tactile sense due to particular pressure and feedback vibrations having a vibration pattern corresponding to the pattern of a speaker's voice input through a voice input device; and transmit the feedback vibrations to the speaker.

The memory 160 can store a program for describing the operation of the controller 180; the memory 160 can also store input and output data temporarily. The memory 160 can store data about various patterns of vibration and sound corresponding to at least one voice pattern input from at least one speaker.

Also, the memory 160 can include a sound model, a recognition dictionary, and a translation database, and a predetermined language model required for the operation of the present invention.

The recognition dictionary can include at least one form of a word, a clause, a keyword, and an expression of a particular language.

The translation database can include data matching multiple languages to one another. For example, the translation database can include data matching a first language (Korean) and a second language (English/Japanese/Chinese) to each other. The second language is a terminology introduced to distinguish from the first language and can correspond to multiple languages. For example, the translation database can include data matching “ [symbol] ” in Korean to “I'd like to make a reservation” in English.

The memory 160 may also include at least one type of storage medium including a flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the display device 100 may be operated in relation to a web storage device that performs the storage function of the memory 160 over the Internet.

Also, the interface unit 170 serves as an interface with external devices connected with the display device 100. For example, the external devices can transmit data to an external device, receive and transmit power to each element of the display device 100, or transmit internal data of the display device 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The controller 180 usually controls the overall operation of a display device. For example, the controller 180 carries out control and processing related to image display, voice output, and the like. The controller 10 can further comprise a voice recognition unit 182 carrying out voice recognition upon the voice of at least one speaker and although not shown, a voice synthesis unit (not shown), a sound source detection unit (not shown), and a range measurement unit (not shown) which measures the distance to a sound source.

The voice recognition unit 182 can carry out voice recognition upon voice signals input through the microphone 122 of the display device 100 or the remote control 10 and/or the mobile terminal shown in FIG. 1; the voice recognition unit 182 can then obtain at least one recognition candidate corresponding to the recognized voice. For example, the voice recognition unit 182 can recognize the input voice signals or voice information by detecting voice activity from the input voice signals or voice information, carrying out sound analysis thereof, and recognizing the analysis result as a recognition unit. And the voice recognition unit 182 can obtain the at least one recognition candidate corresponding to the voice recognition result with reference to the recognition dictionary and the translation database stored in the memory 160.

The voice synthesis unit (not shown) converts text to voice by using a TTS (Text-To-Speech) engine. TTS technology converts character information or symbols into human speech. TTS technology constructs a pronunciation database for each and every phoneme of a language and generates continuous speech by connecting the phonemes. At this time, by adjusting magnitude, length, and tone of the speech, a natural voice is synthesized; to this end, natural language processing technology can be employed. TTS technology can be easily found in the electronics and telecommunication devices such as CTI, PC, PDA, and mobile devices; and consumer electronics devices such as recorders, toys, and game devices. TTS technology is also widely used for factories to improve productivity or for home automation systems to support much comfortable living. Since TTS technology is one of well-known technologies, further description thereof will not be provided.

A power supply unit 190 provides power required for operating each constituting element by receiving external and internal power controlled by the controller 180.

Also, the power supply unit 190 receives external power or internal power and supplies appropriate power required for operating respective elements and components under the control of the controller 180.

Further, various embodiments described herein may be implemented in a computer-readable or its similar medium using, for example, software, hardware, or any combination thereof.

For a hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For a software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

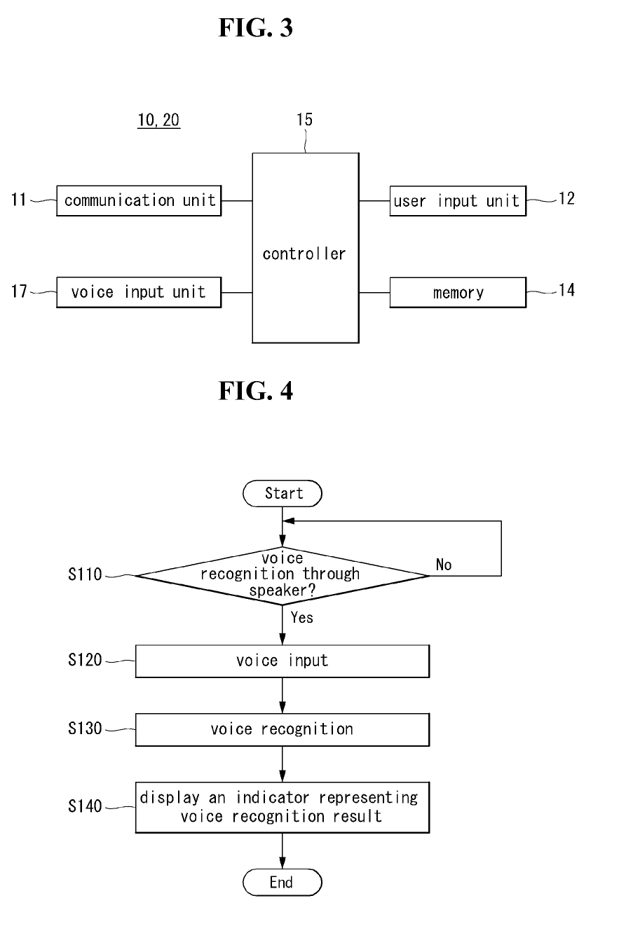

FIG. 3 is an overall block diagram of a remote control related to one embodiment of the present invention.

A remote control 10 related to an embodiment of the present invention can comprise a communication unit 11, a user input unit 12, a memory 13, and a voice input unit 17.

The communication unit 11 transmits information about a speaker's voice signals input through the voice input unit 17 or signals input through a key button unit to the display device 100.

The user input unit 12 is a device intended to receive various kinds of information or commands from the user and can include at least one key button. For example, the key button unit of the remote control 10 can be equipped in the front of the remote control 10.

The memory 13 can store a predetermined program for controlling the overall operation of the remote control 10, temporarily or permanently storing input and output data used when the overall operation of the remote control 10 is carried out by the controller 15; and various data processed.

The voice input unit 17 receives voice signals of a speaker. For example, the voice input unit 17 can correspond to a microphone.

Up to this point, a voice recognition system shown in FIG. 1; and a display device 100 constituting the voice recognition system and at least one voice input device (a remote control 10, a mobile device 20, a microphone array 30, and so on) transmitting a speaker's voice to the display device 100 have been described.

In what follows, to describe a flow diagram of a control method for an electronic device according to embodiments of the present invention and the flow diagram in more detail, examples displayed on the screen of a display device will be referred to.

FIG. 4 is a flow diagram illustrating a control method for a display device 100 according to an embodiment of the present invention. In the following, a control method for the display device 100 will be described with reference to related drawings.

The display device 100 determines whether a speaker's voice is input from at least one voice input device S110. Input voice for the display device 100 can be not only the voice coming directly from the speaker but it can be a sound rather than a voice command related to the display device 100 such as a mechanical sound, an external noise, and the like. In this case, the display device 100 may not perform voice recognition upon the sound not related to the voice command.

The display device 100 can carry out voice recognition upon the case where at least one speaker's voice is received from the at least one voice input device S120 and upon the received voice S130.

At this time, the display device 100 can receive voice from the at least one speaker simultaneously or sequentially with a predetermined time interval. For example, when two speakers generate voice at the same time, the display device 100 can display a voice recognition error message on the display unit 151. Also, when voice is received sequentially, the display device 100 carries out voice recognition according to the order of the corresponding input sequence; on the other hand, when another voice is input while voice recognition is carried out upon particular voice, a voice recognition error message can be displayed on the display unit 151.

Afterwards, the display device 100 can display an indicator indicating a voice recognition result on the display unit 151, S140. The display device 100 can display the voice recognition result on the display unit 151 by using an indicator related to at least one of the speaker, the voice input device, and the voice recognition result.

The indicator related to the speaker is an indicator capable of identifying the speaker, which can include text, an image, a sound signal, a display setting value corresponding to a particular speaker, and a voice pattern of the particular speaker.

The text can include a description of the speaker, ID, nickname information, etc. For example, the controller 180, if a voice generated by a speaker “John” is recognized, can display text information corresponding to “John” in a particular area of the display unit 180.

The image can include a picture of the speaker, an avatar designated by the speaker, etc. For example, the controller 180, if a voice generated by a speaker “John” is recognized, can display an avatar image corresponding to “John” in a particular area of the display unit 180.

The sound signal, after the controller 180 of the display device 100 recognizes a speaker's voice, can output information related to the speaker's profile such as a name, a nickname, etc. by converting the information into a predetermined voice signal.

The display setting value corresponding to the particular speaker includes display background color, text color, skin information, etc. and can be set beforehand according to speakers. For example, the controller 180, if a voice generated by a speaker “John” is recognized, can change the background color of the display unit 180 to black.

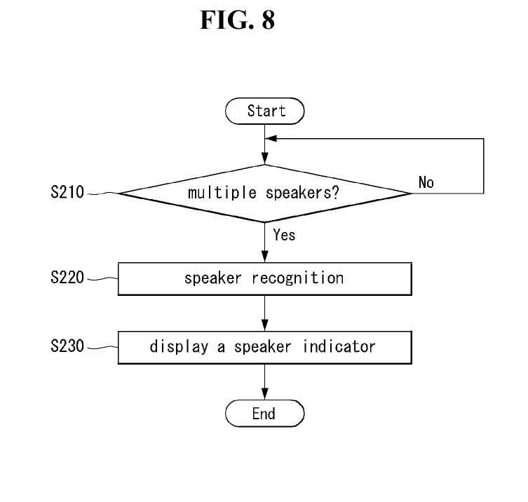

However, the scope of the present invention is not limited to the above description. For example, in the aforementioned examples, although a speaker indicator is displayed by referring to predetermined profile information previously set up related to a particular speaker, the display device 100 according to one embodiment of the present invention can display the speaker indicator corresponding to a voice input of a particular speaker even when there is no information about the particular speaker. Regarding to the above description, a more detailed description will be given with reference to FIGS. 8 to 17.

Meanwhile, the indicator related to the voice input device is the one for identifying a voice input device used by at least one speaker who generates the voice. For example, it is assumed that a speaker 1 inputs his or her voice by using a remote control (10 of FIG. 1) and a speaker 2 inputs his or her voice by using a mobile device (20 of FIG. 1). In this case, the controller 180 can recognize that a voice has been input by a predetermined remote control 10 and at the same time, a voice has been input by a predetermined mobile terminal 20.

In this case, therefore, the display device 100 does not know if a voice input from the remote control 10 comes from a speaker 1 or a speaker 2, but can recognize the input device providing the voice. Accordingly, the display device 100, by displaying a remote icon representing the remote control 10 on the display unit 151 when the speaker 1 generates his or her voice, can eventually help identify the speaker.

On the other hand, an indicator related to the reliability of voice recognition indicates the one related to the accuracy of voice recognition. Suppose that a speaker generates a voice command at a location separated by a predetermined distance from the display device 100. In this case, if the distance between the speaker and the display device 100 is found to be long according to a predetermined criterion, the display device 100 cannot accurately recognize the voice command generated by the speaker. It is because signal strength of a voice from the speaker is reduced in inverse proportion to distance.

Therefore, the indicator related to the reliability of voice recognition can include signal strength of noise detected by the display device 100 in consideration of strength of a voice signal generated by a speaker, information related to the separation distance between the speaker and the voice input device, and the separation distance. However, the scope of the present invention is not limited to the above.

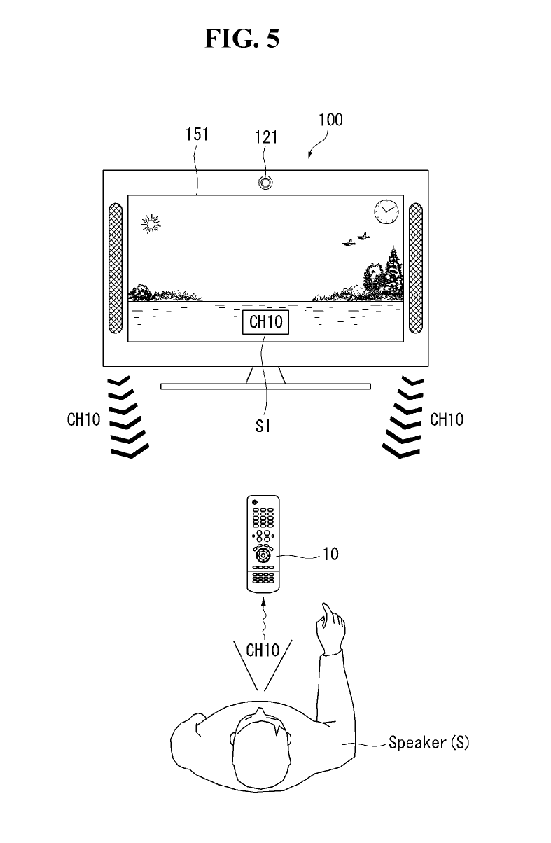

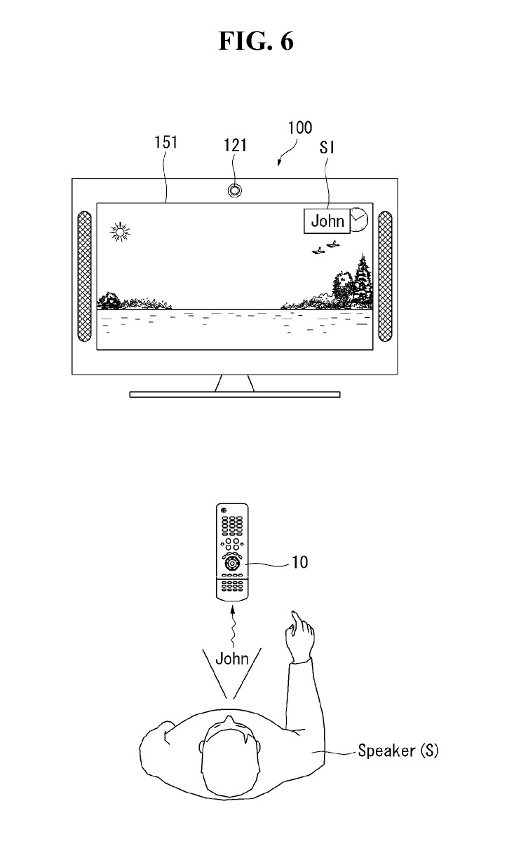

FIGS. 5 to 6 illustrate examples of displaying an indicator corresponding to voice signals of a speaker received through a predetermined voice input device on a display unit. In what follows, it is assumed that the display device 100 is a smart TV. Now, a procedure of displaying an indicator corresponding to a voice signal of the speaker on the display unit will be described with reference to related drawings.

The display device 100 can be equipped with a display unit 151 and a sound output module 152 to provide an indicator relevant to the speaker's voice.

With reference to FIG. 5, if a speaker S says “CH 10” toward the microphone of the remote control 10, the controller 180 can recognize the voice of the speaker S and display the recognition result on the display unit 151 in the form of text of “CH 10”.

Also, the controller 180, after recognizing the voice of the speaker S, can display the recognition result in the form of a sound of “CH 10” through the left and right sound output module 152 of the display device 100.

Accordingly, the speaker S, from the text (CH 10) displayed on one area of the display unit 151 and a sound signal (CH 10) output through the sound output module 152, can know that his or her voice (CH 10) has been recognized by the display device 100.

In other words, as the display device 100 outputs the voice signal of a speaker in a visual or aural form, the speaker can know that his or her voice (CH 10) has been recognized by the display device 100.

The display device 100, however, by outputting data different from the voice signal of the speaker in a visual or aural form, can make the speaker feel the same effect.

For example, with reference to FIG. 6, though the speaker says “CH 10”, the display device 100 displays the name (John) of the speaker S in the form of text on the display unit 151 and thus, the speaker S can know that his or her voice is recognized by the display device 100.

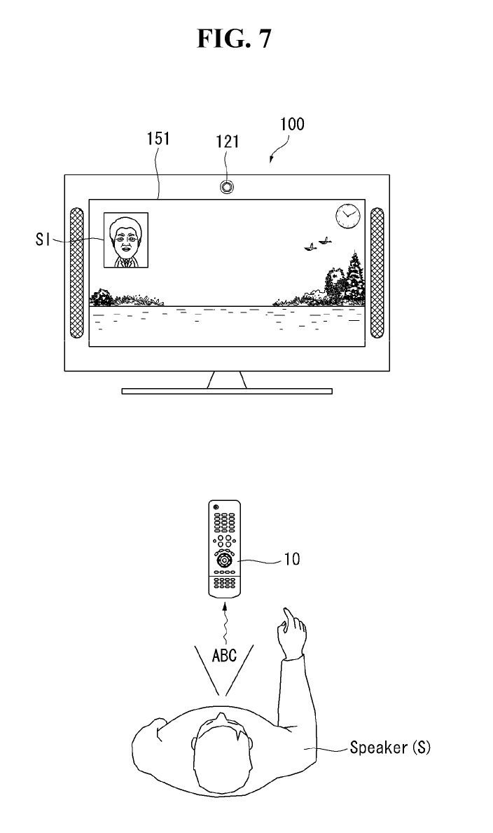

In addition, with reference to FIG. 7, a voice generated by the speaker S may have no relationship with an image displayed on the display unit 151. However, the indicator displayed on the display unit 151 is an avatar for identifying the speaker S; accordingly, the speaker S can know that his or her voice is recognized by the display device 100.

Meanwhile, although not shown in FIG. 7, an image reflecting the shape of the remote control 10 can be displayed on the display unit 151 for the voice generated by the speaker S in FIG. 7. In the same way, though the input device indicator displayed on the display unit 151, the speaker S can know that his or her voice is recognized by the display device 100.

Up to this point, with reference to FIGS. 5 to 7, various examples of providing feedback of a voice recognition result upon the voice of a speaker have been described. In the following, various embodiments of providing feedback on a voice recognition result according to speaker recognition will be described for the case of multiple speakers.

Meanwhile, the display device 100's “recognizing a speaker” can be interpreted as the display device 100's recognizing identify information of a speaker who generates a predetermined voice. At this point, the identity information of a speaker indicates personal information of the speaker.

Also, the display device 100 can perform voice recognition without a procedure of recognizing identity information of the speaker. For example, the display device 100, while displaying a predetermined speaker indicator, can change direction to which the speaker indicator points. This corresponds to the case where the display device 100 recognizes a speaker only with the speaker's location in addition to identity information of the speaker.

FIG. 8 is a flow diagram illustrating a control method for a display device according to another embodiment of the present invention. In what follows, a control method for the display device will be described with reference to related drawings.

With reference to FIG. 8, the display device 100 carries out voice recognition according to a predetermined criterion S220 when voice received from at least one voice input device is generated by multiple speakers S210.

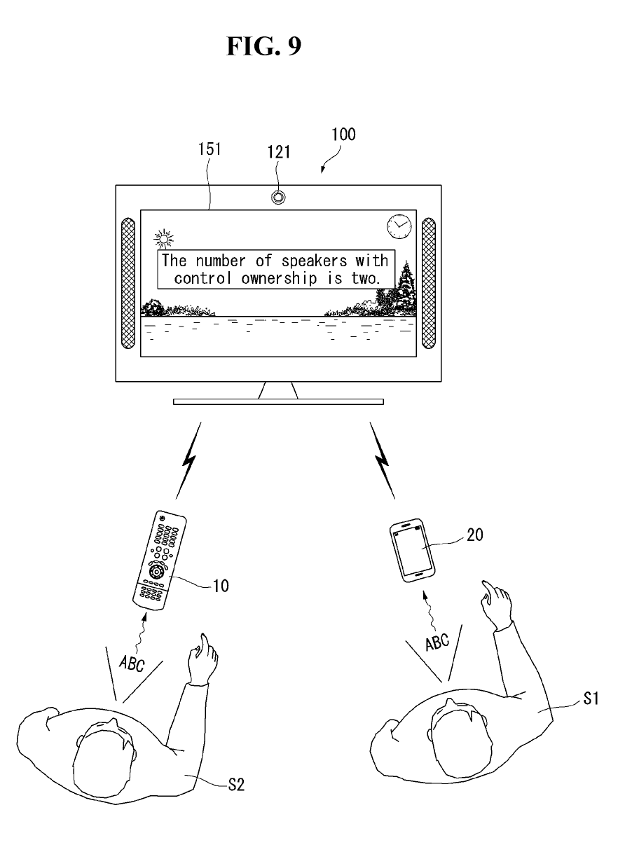

FIG. 9 is an example of a message window indicating multiple control right owners controlling a display device 100 through voice commands in the case of multiple speakers according to the control method for the display device 100 shown in FIG. 8.

The predetermined criterion indicates that speaker recognition can be carried out based on speaker identity information; and speaker recognition can be carried out based on speaker's location. However, the scope of the present invention is not limited to the description above.

The controller 180 can display a speaker indicator for identifying a speaker recognized according to the criterion on the display unit 151, S230.

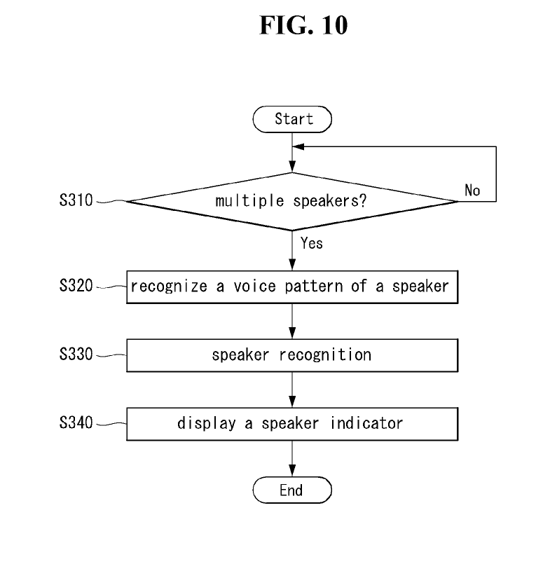

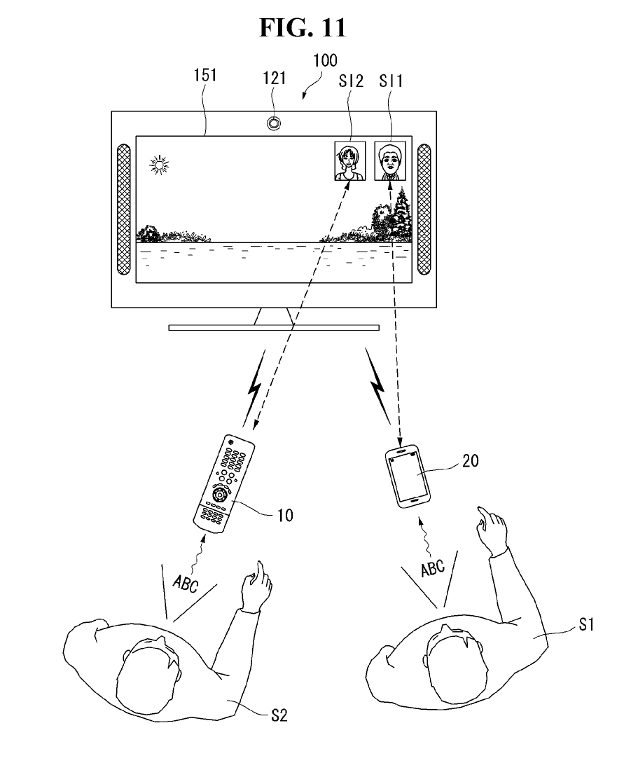

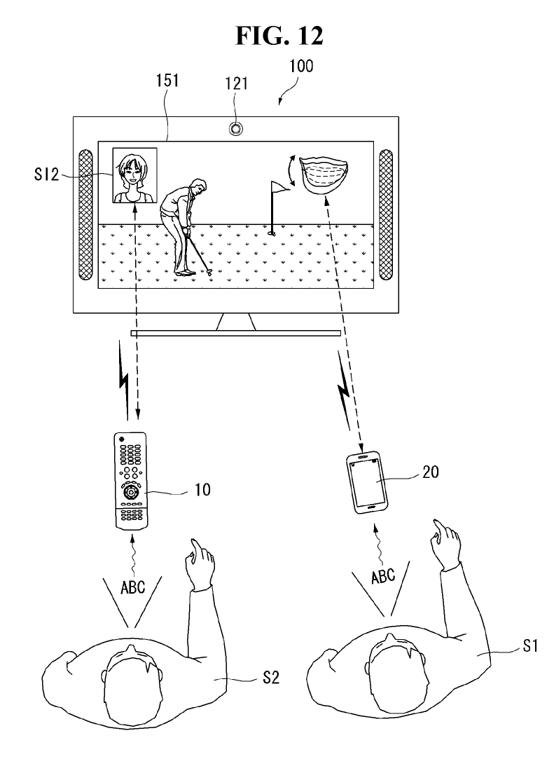

FIG. 10 is a flow diagram of a control method for a display device according to an embodiment of the present invention. FIGS. 11 to 12 illustrate examples of displaying a speaker indicator according to the control method for a display device illustrated in FIG. 10.

With reference to FIG. 10, in the case of multiple speakers S310, the controller 180 can recognize a voice pattern of a speaker received through a voice recognition device and carry out voice recognition according to the voice pattern S330.

The memory 160 can store a reference voice pattern of each speaker. The reference voice pattern can be obtained through a repetitive voice input procedure. More specifically, the controller 180 can extract a feature vector from a voice signal generated by a speaker; calculates a probability value between the extracted feature vector and at least one speaker model pre-stored in a database; and carry out speaker identification determining whether the speaker is the one registered in the database based on the calculated probability value or speaker verification determining whether the speaker's access has been made in a proper way.

The controller 180 can display a speaker indicator on the display unit 151 based on a voice recognition result.

For example, with reference to FIG. 11, the controller 180 can recognize a first speaker S1 and a second speaker S2 respectively and display a first speaker indicator (SI1, a first avatar) corresponding to the first speaker S1 and a second speaker indicator (SI2, a second avatar) corresponding to the second speaker S2 on the display unit 151.

As described above, the controller 180 can display a speaker indicator for identifying the first and the second speaker in addition to the first and the second avatar. For example, while the first avatar is displayed for identifying a first speaker, to identify the second speaker, an input device indicator corresponding to a voice input device used by the second speaker can be displayed along with the first avatar. Accordingly, each speaker can know that his or her voice is recognized by the display device 100.

Meanwhile, if the controller 180 fail to recognize a speaker while receiving a voice input from at least one speaker, the controller 180 can display a message window notifying of the speaker recognition failure on the display unit 151.

On the other hand, the speaker indicator can include a dynamic indicator. The dynamic indicator implies an indicator which can change its shape as a predetermined event occurs like a widget in a mobile terminal environment. For example, as shown in FIG. 12, while the first speaker S1 generates his or her voice, a first speaker indicator SI1 corresponding to the first speaker S1 can change its shape continuously.

Up to this point throughout FIGS. 10 to 12, an example has been described, where a voice generated by a speaker is recognized; a speaker is recognized based on voice recognition; and an indicator for an individual speaker according to the speaker recognition is displayed on a display unit.

In what follows, described is a procedure of recognizing a speaker by recognizing the speaker's location and changing a pointing direction of a speaker indicator displayed on the display unit 151 according to the speaker's location.

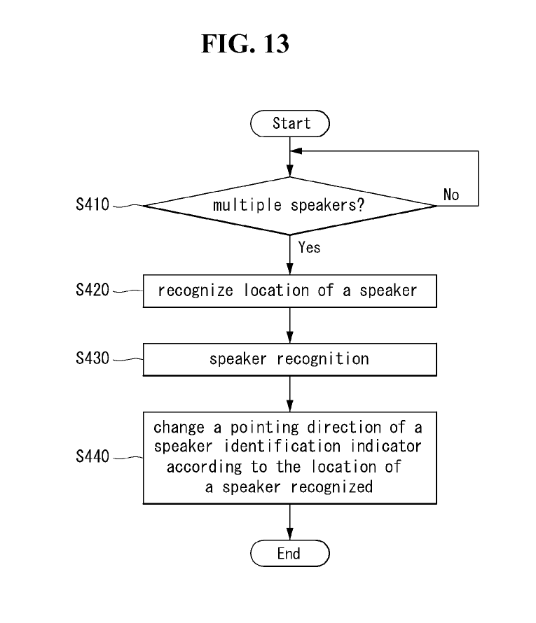

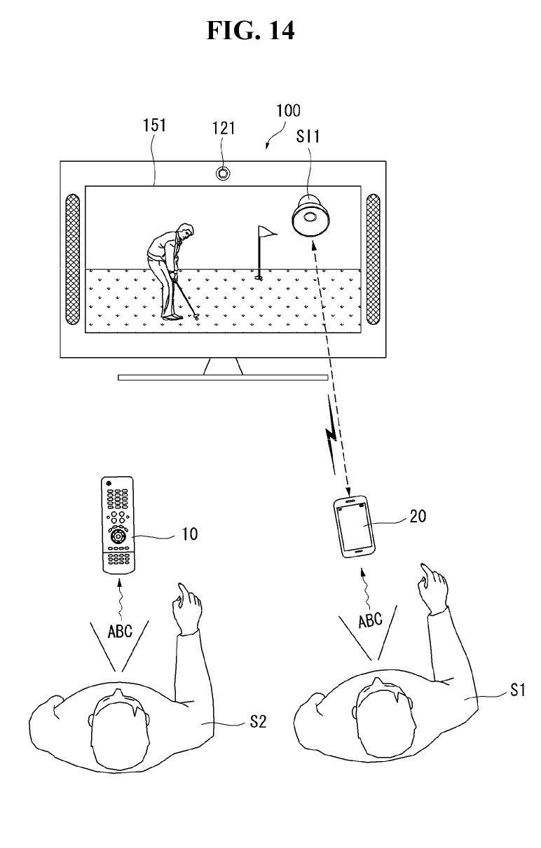

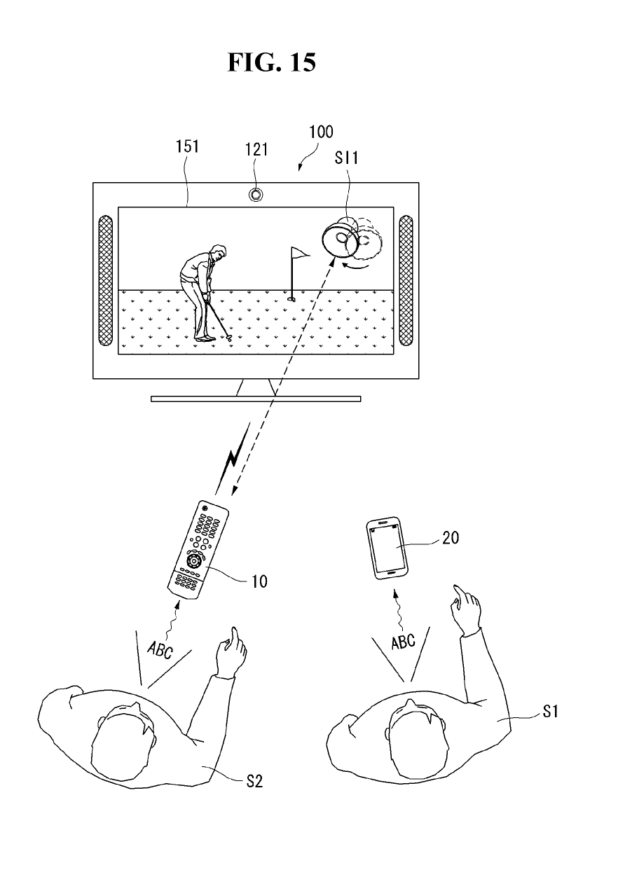

FIG. 13 is a flow diagram of a control method for a display device according to an embodiment of the present invention. FIGS. 14 to 15 illustrate examples of a speaker indicator according to the control method of a display device illustrated in FIG. 13.

With reference to FIG. 13, in the case of multiple speakers S410, the controller 180 can recognize a speaker's location S420, recognize the speaker as the speaker's location is recognized, and change a pointing direction of a speaker indicator according to the speaker's location recognized S440.

Meanwhile, the speaker indicator can include a dynamic indicator. The dynamic indicator can change its pointing direction. The controller 180 can change the pointing direction of the dynamic indicator toward a speaker's location.

For example, with reference to FIGS. 14 and 15, while a first speaker S1 is generating a voice, a first speaker indicator SI1 points toward the first speaker S1. Accordingly, the first speaker S1 can know by noticing the pointing direction of the first speaker indicator SI1 that his or her voice is recognized by the display device 100. Afterwards, when a second speaker S2 generates speech sounds after completion of the first speaker S1's phonation, the first speaker indicator SI1 can change its pointing direction from the first speaker S1 to the second speaker S2. The second speaker S2, by noticing a second speaker indicator S2 pointing toward himself or herself, can know that his or her voice is recognized by the display device 100.

As described above, by recognizing a current location of a speaker, the speaker can be recognized without knowing speaker identify information.

At this time, there are many ways to know a speaker's location. For example, with reference to FIGS. 14 and 15, the first speaker S1 provides his or her voice through a mobile terminal 20 while the second speaker S2 through a remote control 10. A voice received by the remote control 10 and the mobile terminal 20 can be transmitted to the display device 100 through a predetermined communication means, for example short range communication. Therefore, the location of the first S1 and the second speaker S2 can be known by transmitting their location to the display device 100 through a location information module of each terminal.

On the other hand, the location of each speaker can be obtained through a camera attached on the display device 100. The camera 121 can receive a gesture command by capturing a speaker's gesture. In what follows, described will be a procedure of recognizing a speaker's location through a camera and changing a pointing direction of a speaker indicator according to the speaker's location recognized.

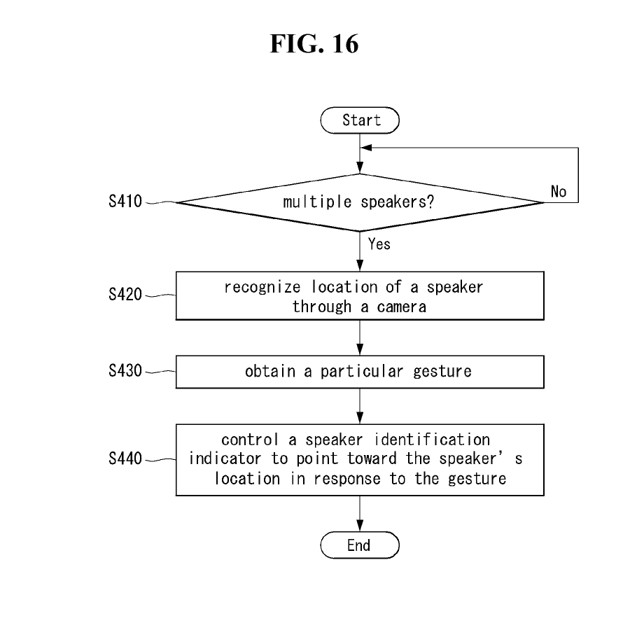

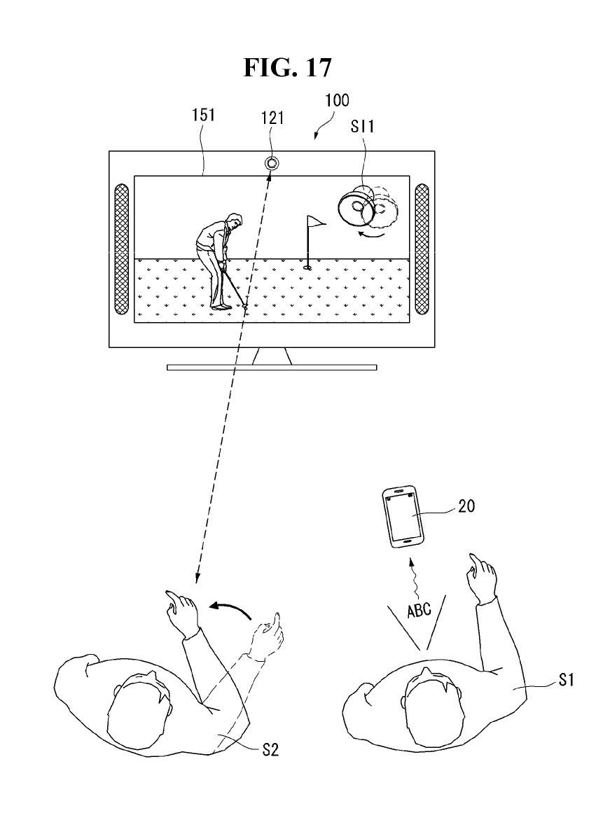

FIG. 16 is a flow diagram of a control method for a display device according to an embodiment of the present invention. FIG. 17 illustrates an example of displaying a speaker indicator according to the control method of a display device illustrated in FIG. 16.

With reference to FIG. 16, in the case of multiple speakers S510, the controller 180 can recognize a speaker's location S520 through a camera 121 and obtain a particular gesture motion from the speaker S530.

The particular gesture can correspond to a motion related to obtaining control right with which the operation of the display device 100 can be controlled through a voice command. For example, with reference to FIG. 17, a first speaker S1 owning a control right, a predetermined voice command can be input to the display device 100 through a mobile terminal 20.

At this time, as a second speaker S2 makes a gesture of moving his or her hand from right to left, the controller 180 can interpret the hand gesture obtained by the camera 121 as a command for obtaining a control right.

Also, the controller 180, by changing the pointing direction of a speaker indicator S12 from the first speaker S1 to the second speaker S2, can notify that the second speaker S2 owns the control right. Therefore, the second speaker S2 can know from the pointing direction of the speaker indicator S12 that the control right for the display device 100 belongs to him or her.

As described above, as a voice generated from at least one speaker is recognized and the voice recognition result is provided through the display unit 151 according to a predetermined criterion, a speaker can check in real-time that his or her voice is recognized through the display device 100.

Meanwhile, for speaker recognition, each speaker can set up his or her user profile beforehand. By preparing the user profile, a particular speaker's voice can be recognized and a speaker indicator for identifying the recognized speaker and/or a user profile according to the speaker can be provided to the display unit.

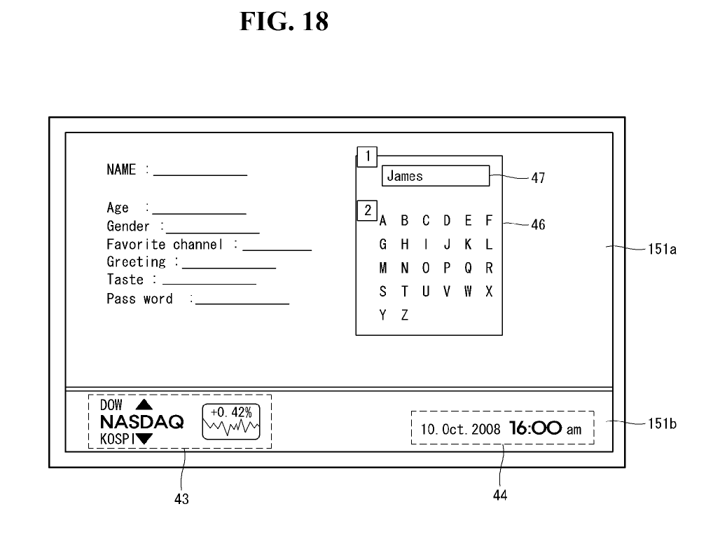

FIG. 18 illustrates setting a user profile according to one example of a control method for a display device according to one embodiment of the present invention; and operations of the display device 100 to implement the above will be described in detail.

The controller 180 turns on the power of the display device 100 by receiving a signal commanding provision of power to the display device 100 from a key input of the remote control 10.

When the display device 100 is turned on, the controller 180 displays a predetermined initial display on the display unit 151 from the memory 160.

The display unit 151 can be divided into a first display unit 151a and a second display unit 151b.

The controller 180 can display a user registration window 45 for setting up user profiles on the display unit 151.

Each element of a user profile can be input through the displayed user registration window 45. The input can be carried out by a remote control or a voice command described above.

A user profile can include at least one of a user's name, sex, age, and hobby. Also, the user profile can further include password information. The password is a unique number which a particular user of family members can set up; if a password input is provided for the user profile of the particular user, the display device 100 can be operated in the environment customized for the particular user.

Stock information 33, time information 34, and so on can be displayed in the second display unit 151b which can be installed physically separated from the first display unit 151a.

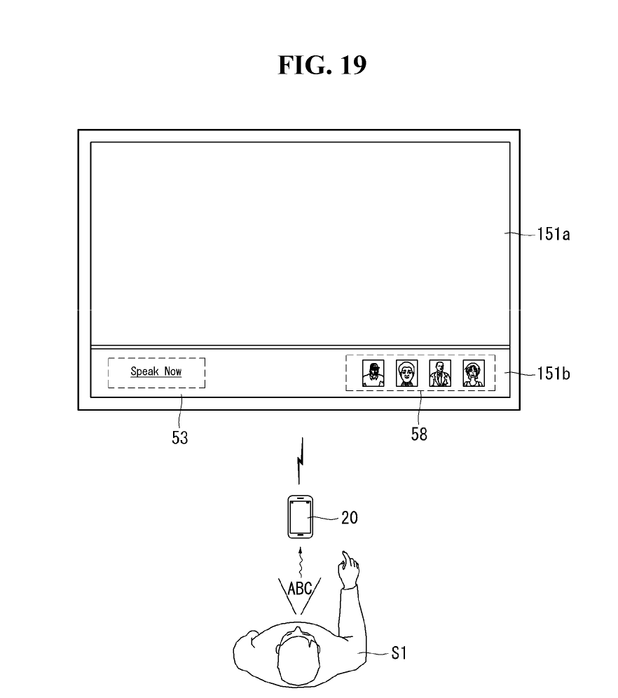

FIG. 19 is an example of a screen where icons for the respective speakers are displayed on the display unit. As shown in FIG. 19, the controller 180 displays multiple icons for the respective speakers on the second display unit 151b. The number of icons for the respective speakers displayed on the second display unit 151b corresponds to the number of previously registered users.

According to the control method for a display device according to an embodiment of the present invention, a first speaker S1 transmits a predetermined voice to the display device 100 through a mobile terminal 20.

The display device 100 can carry out voice recognition upon the voice of the first speaker S1 and select a speaker icon corresponding to the first speaker S1 from multiple speaker icons 58 based on the voice recognition result.

The speaker icon selected can be displayed separately from speaker icons not selected. For example, the speaker icon selected can be displayed being highlighted.

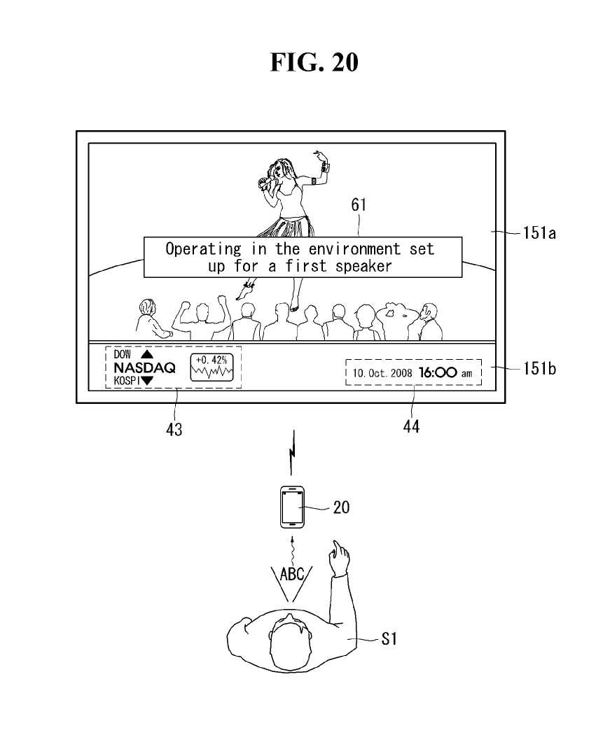

If one speaker icon is selected from the icons of the respective icons 58, the controller 180, as shown in FIG. 20, controls the display device 100 to operate in the environment set up by the first speaker S1.

For example, as shown in FIG. 20, it can be known that the first speaker S1 has set up a “Music” program as his or her favorite or high priority program. Therefore, according to a control method for a display device according to an embodiment of the present invention, the display device 100 can receive a speaker's voice through a voice input device, carry out voice recognition upon the received voice, recognize a speaker corresponding to the voice recognition result, and control itself to operate in the environment set up by the speaker.

Up to this point, it has been described that voice recognition can be carried out efficiently in the environment for a TV voice recognition system through a speaker indicator as more than one speaker exists.

In what follows, described is a procedure of carrying out voice recognition efficiently in the environment for a TV voice recognition system through an input device indicator as the at least one speaker provides a voice through at least one voice input device.

Besides, control operation of a display device according to the distance between a speaker and a voice input device in the case of multiple voice input devices will be described.

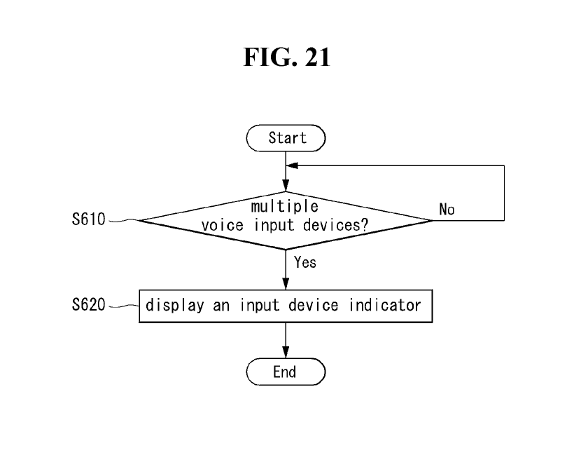

FIG. 21 is a flow diagram of a control method for a display device according to an embodiment of the present invention.

With reference to FIG. 21, when multiple voice input devices are employed S610 for receiving a speaker's voice, the display device 100 can display the input device indicator on the display unit 151, S620.

The voice input device can be divided into a user terminal (a first voice input device) such as the remote control 10 controlling the operation of the mobile terminal 20 and the display device 100, which can be operated by the user; and a second voice input device such as a microphone installed inside the display device 100 and at least one microphone array prepared near the display device 100, which is difficult for the user to operate.

The controller 180 can display an input device indicator helping the user identify if a user voice input device corresponds to the first voice input device or the second voice input device on the display unit 151.

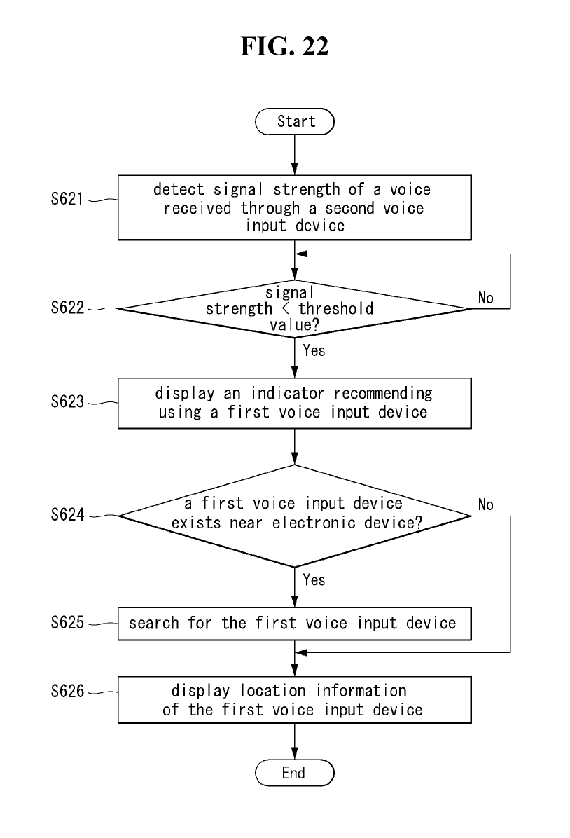

In what follows, with reference to FIGS. 22 to 26, described in detail is a procedure for the controller 180 to display the input device indicator on the display unit 151.

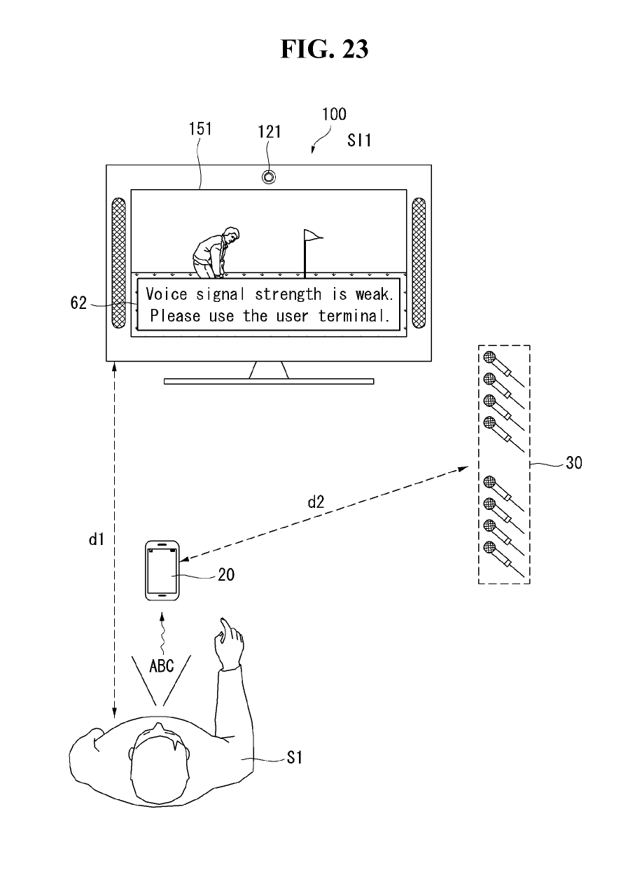

FIG. 22 is a flow diagram illustrating the S620 step of FIG. 21 in more detail. FIGS. 23 to 26 illustrate examples of an indicator related to an input device according to the control method of a display device illustrated in FIG. 22.

First, with reference to FIG. 22, it is assumed that a voice input to the display device 100 is received through a second voice input device.

The controller 180 of the display device 100 detects strength of a voice signal received through the second voice input device S621. As described above, the second voice input device is a microphone embedded in the display device 100 (e.g., a smart TV) or a microphone array prepared near the smart TV; and reveals weak mobility and usually located at a relatively long distance from a speaker.

Therefore, signal strength of a voice signal received through the second voice input device is usually weak. Accordingly, the controller 180, if signal strength of a voice signal received through the second voice input device is below a predetermined threshold value S622, can recommend the user for using the first voice input device and display an indicator for the recommendation on the display unit 151, S623.

The display device 100 can determine whether the first voice input device exists near the display device 100, S624.

If the first voice input device does not exist near the display device 100, the display device 100 can search for the location of the first voice input device S625.

Afterwards, if the location of the first voice input device is recognized, the display device 100, by displaying location information of the first voice input device, can strongly recommend the user for using the first voice input device.

With reference to FIG. 23, a speaker possesses a mobile terminal 20 but it is assumed that the mobile terminal 20 is not employed as a voice input device for the display device 100.

The distance d1 between the display device 100 and a speaker; and the distance d2 between the speaker and a microphone array 30 near the speaker is fairly longer than that between the speaker and the mobile terminal 20.

Accordingly, if a speaker uses the second voice input device, since signal strength of a voice signal is weak, the display device 100 can display an indicator 62 proposing re-inputting a voice by using the first voice input device on the display unit 151.

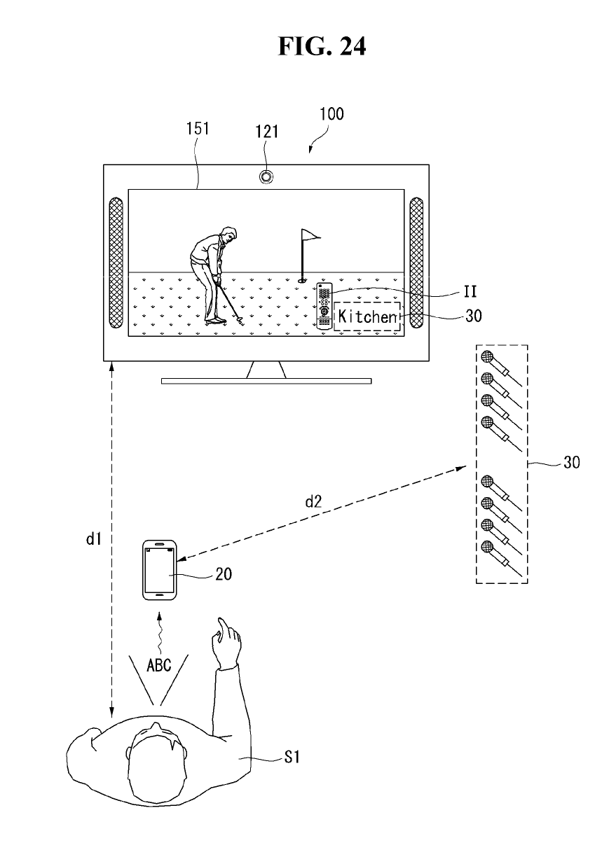

Meanwhile, with reference to FIG. 24, although the display device 100 proposed using the first voice input device, chances are that the first voice input device does not exist near a speaker. In this case, the display device 100 can display location information P of the first voice input device on the display unit 151 along with an indicator II of the first voice input device.

Also, the display device 100 can recognize noise status from a voice signal collected by the voice input device. The display device 100 can recommend use of an appropriate voice input device depending on the noise status.

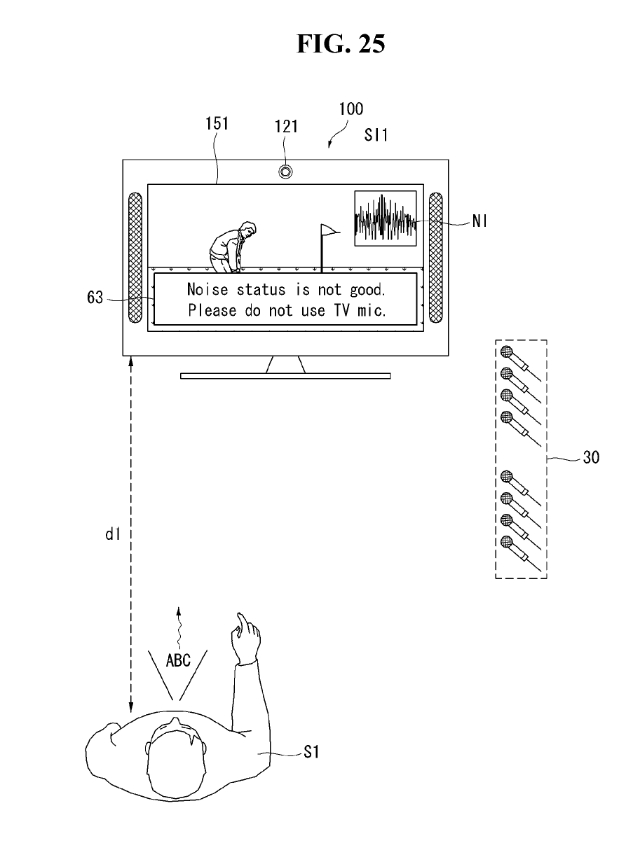

With reference to FIG. 25, the display device 100 can display a noise indicator NI indicating noise status from a speaker's voice input from the voice input device. Meanwhile the controller 180 can display an indicator representing whether a voice input device in current use is available or not.

With reference to FIG. 25, TV 100 and a microphone array 30 exist near a speaker S1 and TV 100 can display that a microphone is not in good condition because of noise. Also, the display device 100 can display an indicator on the display unit 151 indicating that a microphone array 30 can be used additionally.

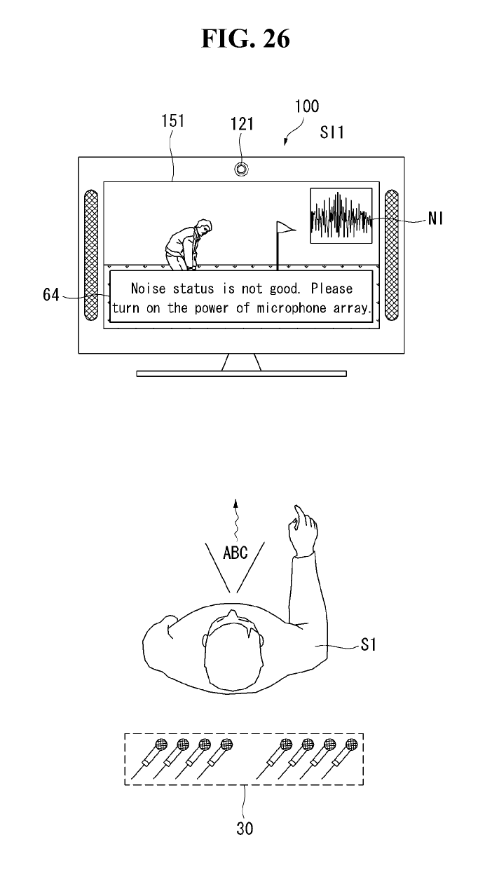

With reference to FIG. 26, the display device 100 can receive a speaker S1's voice through an embedded microphone as described in FIG. 25. Also, noise status of a voice signal received through the embedded microphone can be checked and a noise indicator NI can be displayed on the display unit 151.

In addition, an indicator 64 can be displayed on the display unit 151, recommending using another voice input device due to unfavorable noise status.

The embodiments above described that regarding the environment where voice recognition is carried out, different from the environment for mobile terminals, multiple speakers are supported and multiple voice input devices can be employed; and the embodiments above described various indicator which can be provided for a speaker when voice recognition is carried out by taking account of the environment where multiple voice input devices exist and the distance between a speaker and the voice input device is longer than that between the speaker and a mobile terminal. However, those embodiments described in this document are not limited to the description above. In other words, the present invention can be applied to all the conditions for voice recognition in TV environments.

According to a display device and a control method for the display device according to an embodiment of the present invention, effective voice recognition is possible for TV environments where various constraints exist differently from mobile terminal environments.

Also, in the case of multiple speakers, effective voice recognition is possible in the TV environment through various kinds of feedback to a speaker.

In addition, by using various voice input devices in the TV environment, accuracy of voice recognition can be improved.

The method for providing information of the display device according to embodiments of the present invention may be recorded in a computer-readable recording medium as a program to be executed in the computer and provided. Further, the method for controlling a display device and the method for displaying an image of a display device according to embodiments of the present invention may be executed by software. When executed by software, the elements of the embodiments of the present invention are code segments executing a required operation. The program or the code segments may be stored in a processor-readable medium or may be transmitted by a data signal coupled with a carrier in a transmission medium or a communication network.

The computer-readable recording medium includes any kind of recording device storing data that can be read by a computer system. The computer-readable recording device includes a ROM, a RAM, a CD-ROM, a DVD±ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A display system having a display device, the display device comprising:
a display unit;
a voice information receiving unit; and
a control unit configured to receive voice information from the voice information receiving unit, determine a speaker identity based on the voice information, and display a speaker indicator on the display unit corresponding to the speaker identity.

2. The display system of claim 1, wherein if the voice information receiving unit receives voice information from multiple speakers, the control unit is configured to determine the speaker identity according to a predetermined criterion and display the speaker indicator for identifying the speaker identity on the display unit.

3. The display system of claim 2, further comprising a database storing a reference voice pattern for each of a plurality of speakers, and the control unit is configured to determine the speaker identity by comparing a voice pattern of a speaker input through the voice information receiving unit with each reference voice pattern of the plurality of speakers and display the speaker indicator according to the speaker identity on the display unit.

4. The display system of claim 3, wherein the speaker indicator comprises at least one of text, image, tactile method, and sound signal for identifying the speaker.

5. The display system of claim 3, further comprising at least one voice input device to receive a first voice information from the speaker and transmit second voice information to the voice information receiving unit of the display device.

6. The display system of claim 5, further comprising a plurality of voice input devices, wherein the control unit is configured to display an input device indicator for identifying which of the plurality of voice input devices is receiving the first voice information on the display unit along with the speaker indicator.

7. The display system of claim 3, wherein when the voice pattern of the speaker input through the voice information receiving unit does not match any of the reference voice patterns of the plurality of speakers, the control unit is configured to display an indicator on the display device.

8. The display system of claim 2, wherein the speaker indicator includes a dynamic indicator and the control unit is configured to control motion of the dynamic indicator while the voice information is being received through the voice information receiving unit.

9. The display system of claim 2, wherein the speaker indicator includes a dynamic indicator and the control unit is configured to recognize location of a speaker and change a pointing direction of the speaker indicator according to the location of the speaker.

10. The display system of claim 9, further comprising a camera, wherein the control unit is configured to control the speaker indicator to point toward the location of the speaker in response to a particular gesture motion of the speaker obtained through the camera.

11. The display system of claim 2, further comprising a database storing a user profile including at least one of a voice pattern of a speaker, an image for speaker identification, a user ID, sex, age, and preferred item, wherein the control unit is configured to display the user profile of the speaker based on the voice information.

12. The display system of claim 5, wherein the at least voice input device is a wired or wireless device, including one of a mobile terminal, a smart phone, a game device, a remote control, a microphone installed inside the display device, and a microphone array.

13. The display system of claim 3, further comprising a first voice input device and a second voice input device, wherein the control unit is configured to determine reliability of the speaker identity by taking into account a signal strength of voice information received through the first voice input device and if a strength of voice information received through the second voice input device is below a predetermined threshold value, display an indicator recommending use of the first voice input device on the display unit.

14. The display system of claim 13, wherein the control unit is further configured to display location information of the first voice input device on the display unit.

15. The display system of claim 13, wherein the control unit is further configured to display an indicator representing the signal strength of the voice information received through at least one of the first and second voice input devices on the display unit.

16. The display system of claim 13, wherein the control unit is further configured to display an indicator for identifying noise status according to strength of noise collected through at least one of the first and second voice input devices on the display unit.

17. The display system of claim 16, wherein the control unit, if the strength of noise is above a predetermined threshold value, is configured to display an indicator notifying of unavailability of a voice input device in current use on the display unit.

18. A control method for a display device, comprising:
receiving voice information through a voice information receiving unit;
determining a speaker identity based on the voice information; and
displaying a speaker indicator on a display unit corresponding to the speaker identity.

19. The method of claim 18, if the voice information receiving unit receives voice information from multiple speakers, determining the speaker identity according to a predetermined criterion; and
displaying the speaker indicator for identifying the speaker identity on the display unit.

20. The method of claim 19, wherein the step of determining the speaker identity comprises comparing a voice pattern of a speaker received through the voice information receiving unit with stored reference voice patterns; and
displaying the speaker indicator according to the speaker identity on the display unit.

21. The method of claim 19, further comprising receiving voice information through the voice information receiving unit transmitted from at least one a plurality of voice input devices, wherein the step of displaying the speaker indicator comprises displaying an input device indicator for identifying which of the plurality of voice input devices is receiving the speaker's voice on the display unit along with the speaker indicator.

22. The method of claim 19, wherein the step of displaying the speaker indicator comprises controlling motion of the speaker indicator while the voice information is received through the voice information receiving unit.

23. The method of claim 20, further comprising, when the voice pattern of the speaker input through the voice information receiving unit does not match any of the stored reference voice patterns, displaying an indicator on the display unit.

24. The method of claim 19, wherein the step of displaying the speaker indicator comprises recognizing location of a speaker; and
changing a pointing direction of the speaker indicator according to the location of the speaker.

25. The method of claim 19, wherein the step of displaying the speaker indicator comprises:
recognizing a location of a speaker through a camera;
obtaining a particular gesture motion of the speaker through the camera; and
controlling the speaker indicator to point toward the location of the speaker in response to the gesture motion.

26. The method of claim 19, further comprising:
setting, based on the speaker identity, a user profile including at least one of a voice pattern of a speaker, an image for speaker identification, a user ID, sex, age, and preferred item; and
displaying the user profile corresponding to the speaker identity on the display unit.

27. The method of claim 21, wherein at least one of the plurality of voice input devices is a wired or wireless device, including one of a mobile terminal, a smart phone, a game device, a remote control, a microphone installed inside the display device, and a microphone array.

28. The method of claim 21, wherein, if strength of a voice signal received through a first voice input device is below a predetermined threshold value, an indicator recommending use of a second voice input device is displayed on the display unit.

29. The method of claim 28, further comprising displaying location information of the first voice input device on the display unit.

30. The method of claim 28, further comprising displaying an indicator representing receive sensitivity of the voice signal on the display unit.

31. The method of claim 28, further comprising displaying an indicator for identifying noise status according to strength of noise collected through at least one of the first and second voice input devices on the display unit.

32. The method of claim 31, further comprising, if the strength of noise is above a predetermined threshold value, displaying an indicator notifying of unavailability of a voice input device in current use on the display unit.
